(19) United States
(12) Patent Application Publication
(10) Pub. No.: US 2008/0158098 A1
(43) Pub. Date: Jul. 3, 2008

(54) METHOD OF DRIVING PLASMA DISPLAY PANEL

(75) Inventors: Dongki Paik, Yongin-si (KR); Jongrae Lim, Anyang-si (KR); Tae Heon Kim, Seoul (KR); Wootae Kim, Yongin-si (KR); Sung Chun Choi, Anyang-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/618,512

(22) Filed: Dec. 29, 2006

(51) Int. Cl. G09G 3/28

(52) U.S. Cl. 345/60

(57) ABSTRACT

A method of driving a plasma display panel is disclosed. The method including a scan electrode, a sustain electrode, and a barrier rib includes applying a scan pulse of a positive polarity to the scan electrode for an address period, and applying a data pulse of a negative polarity corresponding to the scan pulse of the positive polarity to the address electrode for the address period. A gap between the scan electrode and the sustain electrode positioned within a discharge cell partitioned by the barrier rib is more than a height of the barrier rib.

### BACKGROUND

1. Field

This document relates to a method of driving a plasma display panel.

2. Description of the Background Art

A plasma display panel (PDP) displays an image comprising a character or a graphic, by exciting phosphors using ultraviolet rays of a wavelength of 147 nm generated at the time of discharging an inert mixture gas of helium and xenon (He+Xe) or neon and xenon (Ne+Xe).

FIG. 1 is a perspective diagram illustrating a structure of a related art three-electrode alternate current surface discharge type plasma display panel (PDP).

As shown in FIG. 1, the three-electrode alternate current surface discharge type PDP includes a scan electrode 11 and a sustain electrode 12 formed on an upper substrate 10, and an address electrode 22 formed on a lower substrate 20.

The scan electrode 11 and the sustain electrode 12 each include transparent electrodes, for example, indium-tin-oxide (ITO) electrodes 11a and 12a. The scan electrode 11 and the sustain electrode 12 each include metal bus electrodes 11b and 12b for reducing a resistance. An upper dielectric layer 13a and a protective film 14 are layered on the upper substrate 10 comprising the scan electrode 11 and the sustain electrode 12.

Wall charges generated in the plasma discharge are accumulated on the upper dielectric layer 13a.

The protective film 14 prevents the upper dielectric layer 13a from being damaged by sputtering generated in the plasma discharge and also, enhances a secondary electron emission efficiency. The protective film 14 uses oxide magnesium (MgO), in general.

A lower dielectric layer 13b and a barrier rib 21 are formed on the lower substrate 20 comprising the address electrode 22. A phosphor layer 23 is coated on the lower dielectric layer 13b and the barrier rib 21.

The address electrode 22 is formed in the direction of intersecting with the scan electrode 11 and the sustain electrode 12. The barrier rib 21 is formed in parallel with the address electrode 22, and prevents visible rays and the ultraviolet rays generated by the discharge from being leaked into an adjacent discharge cell.

The phosphor layer 23 is excited by the ultraviolet rays generated in the plasma discharge, and generates any one of Red, Green, and Blue visible rays.

An inert mixture gas such as helium and xenon (He+Xe) or neon and xenon (Ne+Xe) for discharge is injected into a discharge space of a discharge cell provided between the upper/lower substrates 10 and 20 and the barrier rib 21.

The above driving method for the PDP is mainly classified into a selective writing method and a selective erasing method depending on whether the discharge cell selected by an address discharge for an address period emits light.

The selective writing method turns off an entire screen for a reset period and then, turns on the selected discharge cells for the address period.

Subsequently, the discharge cells selected by the address discharge are sustain discharged for a sustain period, thereby displaying an image.

FIG. 2 is a waveform diagram illustrating a related art driving method for a plasma display panel according to a selective writing method.

As shown in FIG. 2, the PDP is driven by dividing a subfield into a reset period for initializing an entire screen, an address period for selecting a cell, a sustain period for sustaining a discharge of the selected cell, and an erase period for erasing wall charges.

During a setup period of the reset period, all scan electrodes (Y) are concurrently applied a ramp-up waveform. The ramp-up waveform induces a discharge within all cells of the entire screen. By the setup discharge, positive (+) wall charges are accumulated on an address electrode (A) and a sustain electrode (Z), and negative (−) wall charges are accumulated on the scan electrode (Y).

After the supplying of the ramp-up waveform, a ramp-down waveform ramping down from a positive voltage lower than a peak voltage of the ramp-up waveform to base voltage (GND) or a specific negative voltage induces a weak erase discharge within the cells during a setdown period, thereby partially erasing excessive wall charges.

By the setdown discharge, wall charges of a degree for stably inducing the address discharge uniformly remain within the cells.

During the address period, a scan pulse (Scan) of a negative polarity is sequentially applied to the scan electrode (Y) and at the same time, a data pulse (data) of a positive polarity is applied to the address electrode (A) in synchronization with the scan pulse.

As a voltage difference between the scan signal and the address signal and a wall voltage generated during the initialization period are added, the address discharge is generated within the cell to which the data pulse is applied.

The wall charges of a degree for inducing the discharge at the time of applying the sustain voltage are formed within the cells selected by the address discharge.

The sustain electrode (Z) is supplied a positive (+) direct current voltage to reduce a voltage difference with the scan electrode (Y) during the setdown period and the address period, thereby preventing an erroneous discharge with the scan electrode (Y).

During the sustain period, the scan electrode (Y) and the sustain electrode (Z) are alternately applied the sustain pulse. In the cell selected by the address discharge, there occurs a sustain discharge, that is, a display discharge between the scan electrode (Y) and the sustain electrode (Z) whenever each sustain pulse is applied as the wall voltage within the cell and the sustain pulse are added.

After the completion of the sustain discharge at the scan electrode (Y), the ramp waveform is supplied to the sustain electrode (Z), thereby erasing the wall charges remaining within the cells of the entire screen.

A high voltage sustain pulse is used for panel discharge in the driving method for the above plasma display panel. As shown in FIG. 2, a voltage of +Vs based on the ground level voltage is used. In case where the discharge is initiated and sustained using the high voltage, it requires a high voltage Field Effect Transistor (FET). The use of the high voltage FET increases a price of the PDP, and causes a driving error when the PDP is driven at a high voltage, thereby increasing a possibility of inducing the erroneous discharge.

FIG. 3 is a waveform diagram illustrating a related art positive address driving method in an address period.

As shown in FIG. 3, a related art selective writing method is a method in which a ground level voltage (GND) is applied as an address electrode voltage, and an address bias of +Va is applied in the case of an ON cell of a standby state for an address period. The “Va” has a positive value.

However, the related art positive address driving method has a drawback of not effectively performing addressing for turning on/off each cell, and increasing an address voltage and not effectively performing ON/OFF selection and driving of the discharge cell, particularly, in driving a long gap (or wide gap) structure PDP.

In one aspect, a method of driving a plasma display panel including a scan electrode, a sustain electrode, and a barrier rib, the method comprises applying a scan pulse of a positive polarity to the scan electrode for an address period, and applying a data pulse of a negative polarity corresponding to the scan pulse of the positive polarity to the address electrode for the address period, wherein a gap between the scan electrode and the sustain electrode positioned within a discharge cell partitioned by the barrier rib is more than a height of the barrier rib.

A negative voltage of the data pulse of the negative polarity may be applied to the address electrode in a ground level voltage standby state such that an ON cell is selected.

A ground level voltage of the data pulse of the negative polarity may be applied to the address electrode in a positive voltage standby state such that an ON cell is selected.

A negative voltage of the data pulse of the negative polarity may be applied to the address electrode in a standby state of a negative voltage less than a ground level voltage such that an ON cell is selected.

The gap between the scan electrode and the sustain electrode may range from 100 μm to 400 μm.

The gap between the scan electrode and the sustain electrode may range from 150 μm to 350 μm.

A magnitude of a voltage of the scan pulse of the positive polarity applied to the scan electrode may be more than a magnitude of a voltage of the data pulse of the negative polarity applied to the address electrode.

A positive voltage may be applied to the scan electrode in a ground level voltage standby state such that an ON cell is selected.

A positive voltage of the scan pulse of the positive polarity may be applied to the scan electrode in a standby state of a positive voltage, that is greater than a ground level voltage, such that an ON cell is selected.

A positive voltage of the scan pulse of the positive polarity is applied to the scan electrode in a standby state of a negative voltage, that is less than a ground level voltage, such that an ON cell is selected.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 is a perspective diagram illustrating a structure of a related art three-electrode alternate current surface discharge type plasma display panel;

FIG. 2 is a waveform diagram illustrating a related art driving method of a plasma display panel according to a selective writing method;

FIG. 3 is a waveform diagram illustrating a related art positive address driving method in an address period;

FIG. 4 is a waveform diagram illustrating a negative address driving method of a plasma display panel according to an exemplary embodiment of the present invention;

FIG. 5 is a waveform diagram illustrating a negative address driving method of a plasma display panel according to another exemplary embodiment of the present invention; and

FIG. 6 is a waveform diagram illustrating a negative address driving method of a plasma display panel according to a further another exemplary embodiment of the present invention;

FIG. 7 is a waveform diagram illustrating a scan voltage applied to a scan electrode in a negative address driving method of a plasma display panel according to the present invention; and

FIG. 8 is a diagram illustrating an electrode structure of a plasma display panel according to the present invention.

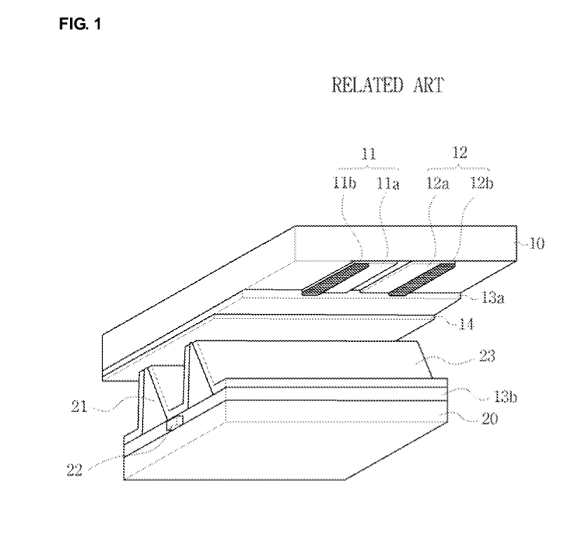

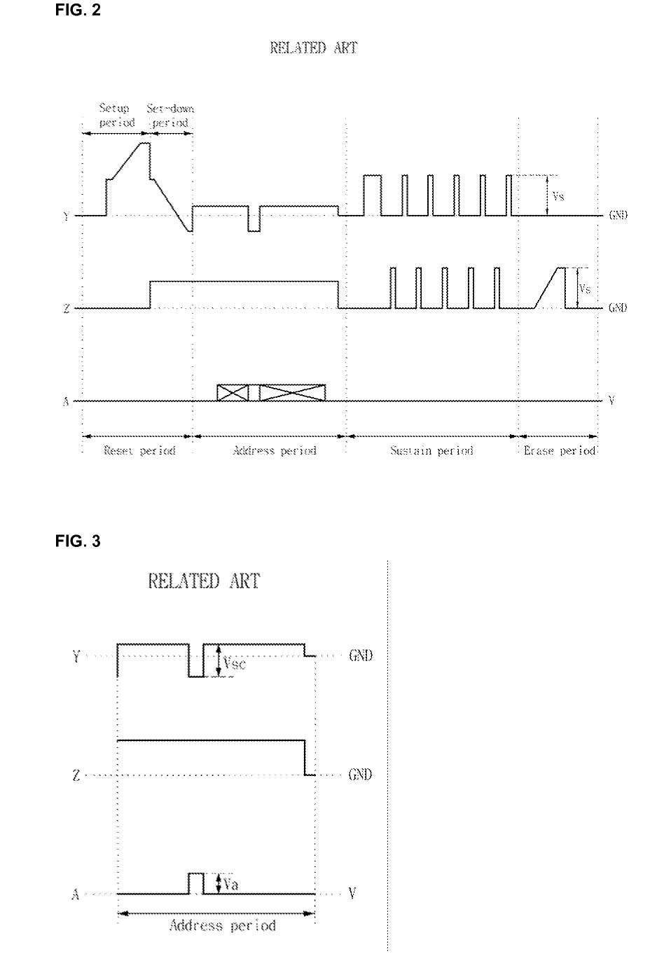

### DETAILED DESCRIPTION OF PREFERRED EMBODIMENTS

Reference will now be made in detail embodiments of the invention examples of which are illustrated in the accompanying drawings.

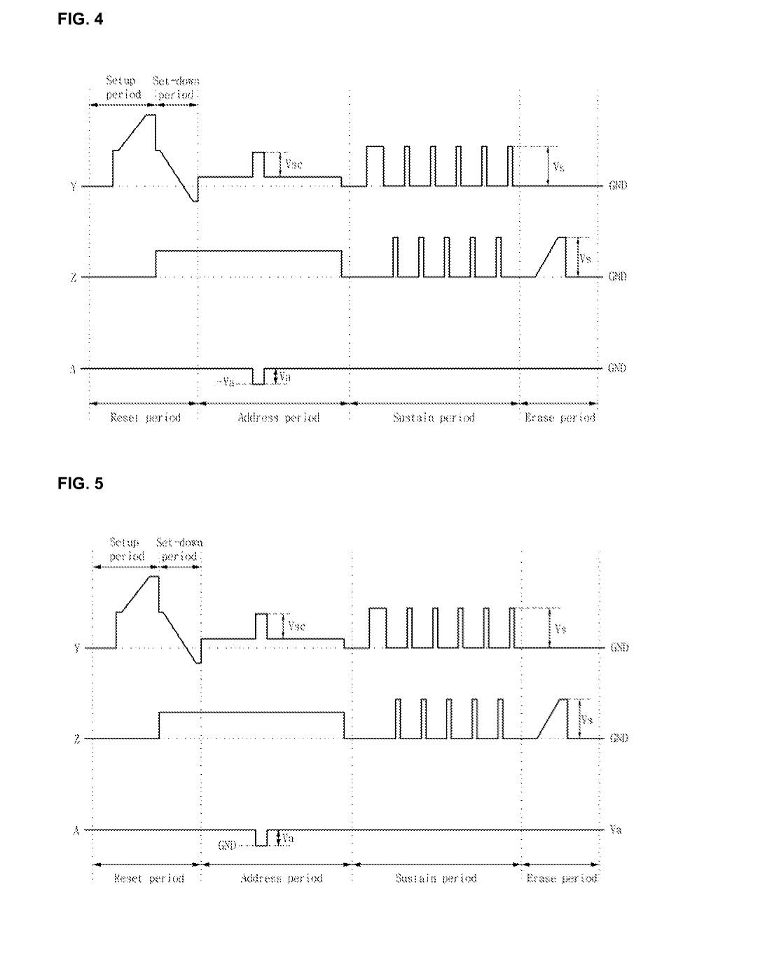

FIG. 4 is a waveform diagram illustrating a negative address driving method of a plasma display panel according to an exemplary embodiment of the present invention.

As shown in FIG. 4, a driving method according to the present embodiment is based on a positive sustain driving method in which a voltage between a positive sustain voltage (+Vs) and a ground level voltage (GND) is alternately applied to each of a scan electrode (Y) and a sustain electrode (Z) during a sustain period. The positive sustain voltage (+Vs) ranges from 160 V to 200 V.

In the present embodiment, a scan pulse of a positive polarity is applied to the scan electrode (Y), and a data pulse of a negative polarity corresponding to the scan pulse of the positive polarity to the address electrode (A) for the address period, thereby performing an addressing operation. In other words, as shown in FIG. 4, a negative voltage (−Va) is applied to the address electrode (A) in a ground level voltage (GND) standby state, thereby selecting an ON cell.

The respective scan electrode (Y) and sustain electrode (Z) are more effective in a long gap structure in which they are spaced a predetermined distance apart by about 100 μm or more.

The scan electrode (Y) and the address electrode (A) each are applied voltages having opposite polarities and, particularly, the scan electrode (Y) is applied a positive scan voltage (Vsc).

As described above, the negative voltage (−Va) is applied to the address electrode (A) in the GND standby state during the address period for addressing, thereby selecting the ON cell in a selective writing method. At this time, “Va” is a positive value, and “−Va” is a negative value.

In view of distribution of wall charges within a discharge cell, it is more desirable that an address discharge is induced when an address voltage changes in polarity and is in a negative state than in the GND standby state. By doing so, an erroneous discharge can be remarkably reduced when the long gap structure plasma display panel is driven.

In order to make the method more effective, the voltage applied to the scan electrode (Y) corresponding to the address voltage has a positive polarity at the time of the address discharge. For example, the voltage (+Vsc) can be applied to the scan electrode (Y) in the GND standby state, thereby selecting the ON cell. It is desirable that the scan pulse of a positive polarity applied to the scan electrode (Y) is greater in magnitude than the data pulse of a negative polarity applied to the address electrode (A).

FIG. 5 is a waveform diagram illustrating a negative address driving method of a plasma display panel according to another exemplary embodiment of the present invention.

As shown in FIG. 5, a driving method according to the present embodiment is based on a positive sustain driving method in which a voltage between a positive sustain voltage (+Vs) and a ground level voltage (GND) is alternately applied to each of a scan electrode (Y) and a sustain electrode (Z) during a sustain period.

In the present embodiment, a scan pulse of a positive polarity is applied to the scan electrode (Y), and a data pulse of a negative polarity corresponding to the scan pulse of the positive polarity to the address electrode (A) for the address period, thereby performing an addressing operation. In other words, as shown in FIG. 4, the ground level voltage (GND) is applied to the address electrode (A) in a positive voltage (+Va) standby state, thereby selecting an ON cell.

A gap between the respective scan electrode (Y) and sustain electrode (Z) has been described in FIG. 4 and thus, its description will be omitted in FIG. 5.

The scan electrode (Y) and the address electrode (A) each are applied voltages having opposite polarities and, particularly, the scan electrode (Y) is applied a positive scan voltage (Vsc).

As described above, a ground level voltage (GND) is applied to the address electrode (A) in the +Va standby state during the address period for addressing, thereby selecting the ON cell in a selective writing method.

In view of distribution of wall charges within a discharge cell, it is more desirable that an address discharge is induced when an address voltage changes in polarity and is in a ground state than in the +Va standby state. By doing so, an erroneous discharge can be remarkably reduced when the long gap structure plasma display panel is driven.

It is desirable that the voltage applied to the scan electrode (Y) has a positive polarity. It has been described in FIG. 4 and thus, its description will be omitted in FIG. 5.

Accordingly, the negative voltage for address driving can be supplied, thereby reducing power consumption, and more efficiently and stably implementing ON/OFF selection and driving of the discharge cell, particularly, in the long gap structure plasma display panel.

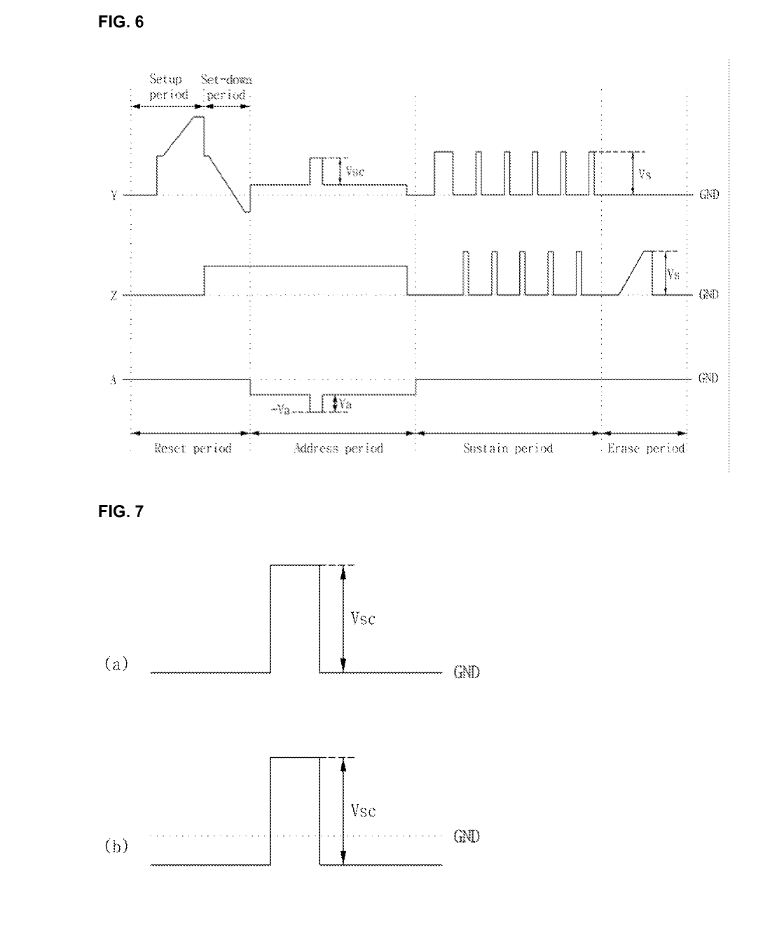

FIG. 6 is a waveform diagram illustrating a negative address driving method of a plasma display panel according to a further another exemplary embodiment of the present invention.

As shown in FIG. 6, a driving method according to the present embodiment is based on a positive sustain driving method in which a voltage between a positive sustain voltage (+Vs) and a ground level voltage (GND) is alternately applied to each of a scan electrode (Y) and a sustain electrode (Z) during a sustain period.

In the present embodiment, a scan pulse of a positive polarity is applied to the scan electrode (Y), and a data pulse of a negative polarity corresponding to the scan pulse of the positive polarity to the address electrode (A) for the address period, thereby performing an addressing operation. In other words, as shown in FIG. 6, the ground level voltage (GND) is applied to the address electrode (A) in a negative voltage (−Va) standby state less than the ground level voltage (GND), thereby selecting an ON cell.

A gap between the respective scan electrode (Y) and sustain electrode (Z) has been described in FIG. 4 and thus, its description will be omitted in FIG. 6.

The scan electrode (Y) and the address electrode (A) each are applied voltages having opposite polarities and, particularly, the scan electrode (Y) is applied a positive scan voltage (Vsc).

As described above, the negative voltage (−Va) is applied to the address electrode (A) in the negative voltage (−Va) standby state less than the ground level voltage (GND) during the address period for addressing, thereby selecting the ON cell in a selective writing method.

In view of distribution of wall charges within a discharge cell, it is more desirable that an address discharge is induced when an address voltage changes in polarity and is in a negative state than in the negative voltage standby state.

It is desirable that the voltage applied to the scan electrode (Y) has a positive polarity. It has been described in FIG. 4 and thus, its description will be omitted in FIG. 6.

Accordingly, the negative voltage for address driving can be supplied, thereby reducing power consumption, and more efficiently and stably implementing ON/OFF selection and driving of the discharge cell, particularly, in the long gap structure plasma display panel.

FIG. 7 is a waveform diagram illustrating the scan voltage applied to the scan electrode in the negative address driving method of the plasma display panel according to the present invention.

Up to now, FIGS. 4 to 6 illustrate that the voltage (+Vsc) is applied to the scan electrode (Y) in the GND standby state so that the voltage applied to the scan electrode (Y) corresponding to the address voltage has the positive polarity at the time of the address discharge, thereby selecting the ON cell. As shown in FIG. 7A, the voltage (+Vsc) can be applied to the scan electrode in the positive voltage standby state greater than the ground level voltage, thereby selecting the ON cell. As shown in FIG. 7B, the voltage (+Vsc) can be applied to the scan electrode in the negative voltage standby state less than the ground level voltage, thereby selecting the ON cell. It is desirable that the positive-direction voltage applied to the scan electrode is greater in magnitude than the negative-direction voltage applied to the address electrode.

As such, the scan voltage applied to the scan electrode corresponding to the address voltage has the positive polarity when the address voltage is applied to the address electrode at the time of the address discharge. If so, the same effect as those of FIGS. 4 to 6 can be substantially obtained. The scan voltage can be applied to the scan electrode for the address period in the positive voltage, ground level voltage, and negative voltage standby states, considering a characteristic of a peripheral temperature of the plasma display panel.

The address driving methods described until now are more effective in the long gap electrode structure plasma display panel. The long gap electrode structure plasma display panel will be described below.

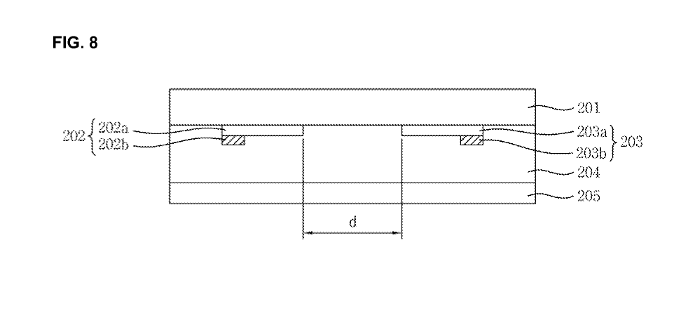

FIG. 8 is a diagram illustrating an electrode structure of the plasma display panel according to the present invention.

Referring to FIG. 8, a discharge cell is, though not shown, partitioned by a barrier rib provided between a front panel and a rear panel. A gap (d) between a scan electrode 901 and a sustain electrode 903 provided on an upper substrate within the discharge cell can be greater than a height of the barrier rib. More desirably, the gap (d) between the scan electrode 901 and the sustain electrode 903 is within a range of about 100 μm to 400 μm. A structure having the gap (d) ranging from about 100 μm to 400 μm between the scan electrode 901 and the sustain electrode 903 is defined as a long gap structure.

That the gap (d) ranges from about 100 μm to 400 μm between the scan electrode 901 and the sustain electrode 903 is to provide the long gap structure plasma display panel and make a positive column region of a discharge region available, thereby maximizing a discharge efficiency of the plasma display panel. More desirably, the gap (d) ranges from about 150 μm to 350 μm between the scan electrode 901 and the sustain electrode 903.

An upper dielectric layer 907 and a protective layer 908 are laminated on the scan electrode 901 and the sustain electrode 903.

As described above, the negative address driving method for the plasma display panel has an effect of supplying the negative voltage for address driving, thereby reducing power consumption, and more efficiently and stably implementing ON/OFF selection and driving of the discharge cell, particularly, in the long gap structure plasma display panel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A method of driving a plasma display panel including a scan electrode, a sustain electrode, and a barrier rib, the method comprising:
applying a scan pulse of a positive polarity to the scan electrode for an address period; and
applying a data pulse of a negative polarity corresponding to the scan pulse of the positive polarity to the address electrode for the address period,
wherein a gap between the scan electrode and the sustain electrode positioned within a discharge cell partitioned by the barrier rib is more than a height of the barrier rib.

2. The method of claim 1, wherein a negative voltage of the data pulse of the negative polarity is applied to the address electrode in a ground level voltage standby state such that an ON cell is selected.

3. The method of claim 1, wherein a ground level voltage of the data pulse of the negative polarity is applied to the address electrode in a positive voltage standby state such that an ON cell is selected.

4. The method of claim 1, wherein a negative voltage of the data pulse of the negative polarity is applied to the address electrode in a standby state of a negative voltage less than a ground level voltage such that an ON cell is selected.

5. The method of claim 1, wherein the gap between the scan electrode and the sustain electrode ranges from 100 μm to 400 μm.

6. The method of claim 1, wherein the gap between the scan electrode and the sustain electrode ranges from 150 μm to 350 μm.

7. The method of claim 1, wherein a magnitude of a voltage of the scan pulse of the positive polarity applied to the scan electrode is more than a magnitude of a voltage of the data pulse of the negative polarity applied to the address electrode.

8. The method of claim 1, wherein a positive voltage is applied to the scan electrode in a ground level voltage standby state such that an ON cell is selected.

9. The method of claim 1, wherein a positive voltage of the scan pulse of the positive polarity is applied to the scan electrode in a standby state of a positive voltage, that is greater than a ground level voltage, such that an ON cell is selected.

10. The method of claim 1, wherein a positive voltage of the scan pulse of the positive polarity is applied to the scan electrode in a standby state of a negative voltage, that is less than a ground level voltage, such that an ON cell is selected.
